(19) United States
(12) Patent Application Publication
(10) Pub. No.: US 2009/0060307 A1
(43) Pub. Date: Mar. 5, 2009

(54) Tensor Voting System and Method

(75) Inventors: Bernard S. Ghanem, Champaign, IL (US); Jianming Liang, Chester Springs, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/198,251

(22) Filed: Aug. 26, 2008

Related U.S. Application Data
(60) Provisional application No. 60/968,112, filed on Aug. 27, 2007.

(51) Int. Cl. G06K 9/00

(52) U.S. Cl. 382/131

(57) ABSTRACT

Described herein is a method and system for facilitating a tensor voting scheme. The tensor voting scheme includes determining at least one voter point and at least one receiver point from input data and determining a tensor vote directed from the receiver point to the voter point.

### CROSS REFERENCE TO RELATED UNITED STATES APPLICATION

This application claims priority from “Tensor Voting Scheme,” U.S. Provisional Application No. 60/968,112 of Ghanem and Liang, filed Aug. 27, 2007, the contents of which are incorporated herein by reference.

### TECHNICAL FIELD

This invention generally relates to a technology for tensor voting which can be applied to multidimensional data.

### BACKGROUND

The technique of tensor voting has been widely used in the fields of image processing and computer vision (e.g., stereo vision and saliency estimation). It typically involves describing the context of receiver points defined in multidimensional data by the accumulation of local information. Local information is accumulated by propagating information from surrounding voter points to the receiver points.

Each voter point casts a separate tensor vote on each receiver point. FIG. 1a shows the geometric layout of how a second order tensor vote is cast by each voter point V on each receiver point R. The tensor vote is typically a rank-1 positive semi-definite matrix dependent on the orientation of the voter point relative to the receiver point (θ), the distance between the voter point and the receiver point (l), a stick tensor with magnitude denoted as |Sᵥ| and a scale factor (σ). The tensor vote is directed towards the origin of the circumscribing circle, thereby giving preference to its boundary. FIG. 1b plots the decay function (DF(s, κ, σ)) of a voter point at the origin, wherein |S|=−1. The decay function emphasizes all the surrounding area 101 close to the boundary 102 of a structure.

The tensor vote TV(V→R) cast by a voter point V on a receiver point R is computed by Equation (1):

$$TV ( V \to R ) = {DF ( s , κ , σ ) [ \frac{- sin ( 2 θ )}{cos ( 2 θ )} ] [ \frac{- sin ( 2 θ )}{cos ( 2 θ )} ]}^{T} \\ where \\ DF ( s , κ , σ ) = \vert {S}_{v} \vert {e}^{\frac{{s}^{2} + c {κ}^{2}}{{σ}^{2}}} , \\ s = \frac{l θ}{sin θ} and \\ κ = \frac{2 sin θ}{l} \qquad ( 1 )$$

The cumulative vote (TV^{R}_{CUM}) received at the receiver point R is the sum of all the second order tensors cast by the voter points on this receiver point R, as shown in Equation (2):

$${TV}_{CUM}^{R} = {\sum }_{i = 1}^{{N}_{V}} TV ( {V}_{i} \to R ) \qquad ( 2 )$$

The tensor voting score (δ_{R}) of the receiver point R is the absolute difference between the positive eigenvalues of TV^{R}_{CUM}, as shown in Equation (3):

∴δ_{R}=λ₁(TV_{CUM}^{R})−λ₂(TV_{CUM}^{R})

The higher the tensor voting score δ_{R} is, the higher the probability that the receiver point R lies on or near the boundary of a smooth curve.

The tensor voting score may be used to identify an object based on its contextual information. In calculating the tensor voting score (δ_{R}) at each receiver point, however, known techniques assume a constant weight for all voter points (sees for e.g., Equation (2)), and do not distinguish between voter points. No information is propagated between the voter points because the voting scheme is performed only pair-wise between a voter point and a receiver point. This technique often results in false identifications of the object (i.e. false positives), because there is no discrimination between receiver points lying inside smooth bounded areas and points lying outside the bounded areas.

As such, what is needed is an improved technique for identifying objects in multidimensional images with a higher level of accuracy.

### SUMMARY

A method and system for facilitating a tensor voting scheme is described herein. The tensor voting scheme includes determining at least one voter point and at least one receiver point from input data, and determining a tensor vote directed from the receiver point to the voter point.

### BRIEF DESCRIPTION OF THE DRAWINGS

The same numbers are used throughout the drawings to reference like elements and features

FIG. 1a illustrates a geometric layout of how a tensor vote is typically cast by a voter point on a receiver point, and FIG. 1b is a two-dimensional plot of the decay function.

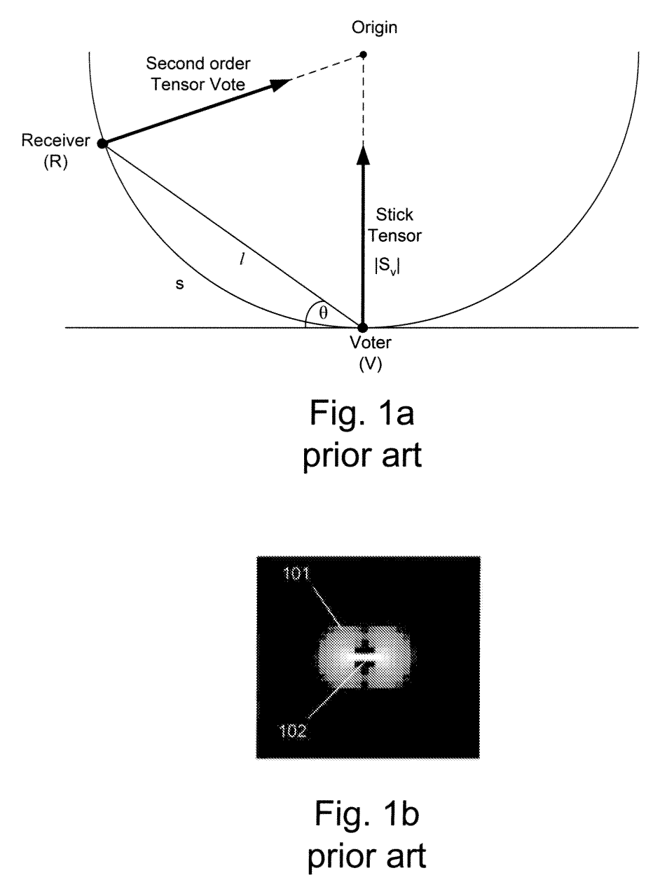

FIG. 2 illustrates an example of a tensor voting system.

FIG. 3 illustrates a methodological implementation of a tensor voting scheme.

FIG. 4a illustrates a geometric layout of how a tensor vote is cast in accordance with one implementation, and FIG. 4b is a two-dimensional plot of the decay function.

FIG. 5 illustrates an exemplary method of detecting contextually-based objects in multidimensional data.

FIGS. 6a-b illustrate images of the tensor voting scores for a pulmonary embolism candidate and a non-pulmonary embolism candidate respectively.

### DETAILED DESCRIPTION

The following description sets forth techniques that facilitate a tensor voting scheme. This scheme may be used in many applications, including computer vision (e.g., stereo vision and saliency estimation), pattern recognition and image processing applications, and any applications which involve multidimensional data possibly contaminated by noise. The techniques may be implemented in many ways, including (but not limited to) computer systems, program modules, dedicated electronics (such as medical imaging devices), and as part of computer networks.

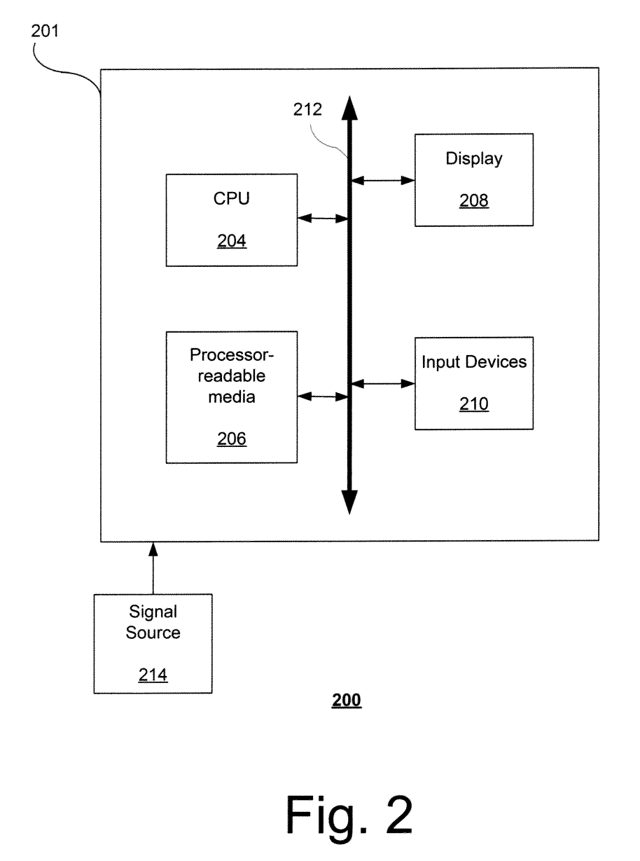

FIG. 2 illustrates an exemplary implementation of a tensor voting system 200. The exemplary tensor voting system 200 includes a computer system 201 for implementing a tensor voting scheme. Computer system 201 may be a desktop personal computer, a portable laptop computer, another portable device, a mini-computer, a mainframe computer, a server, a storage system, a dedicated digital appliance, or another device having a storage sub-system configured to store a collection of digital data items.

In one embodiment, computer system 201 comprises a processor or central processing unit (CPU) 204 coupled to one or more processor-readable media 206 (e.g., computer storage or memory), display device 208 (e.g., monitor) and various input devices 210 (e.g., mouse or keyboard) via an input-output interface 212. Computer system 201 may further include support circuits such as a cache, power supply, clock circuits and a communications bus. Processor-readable media 206 may include random access memory (RAM), read only memory (ROM), disk drive, tape drive, and other types of memories, or a combination thereof.

The tensor voting techniques described herein may be implemented as processor-executable instructions stored in processor-readable media 206. The processor-executable instructions may be executed by CPU 204 to process the input signal (e.g., computed tomography or CT images) from signal source 214 (e.g., CT scanner). As such, the computer system 201 is a general-purpose computer system that becomes a specific purpose computer system when executing the processor-executable instructions.

Computer system 201 may also include an operating system and microinstruction code. The various tensor voting techniques described herein may be implemented either as part of the microinstruction code or as part of an application program or software product, or combination thereof, which is executed via the operating system. Various other peripheral devices, such as additional data storage devices and printing devices, may be connected to the computer system 201.

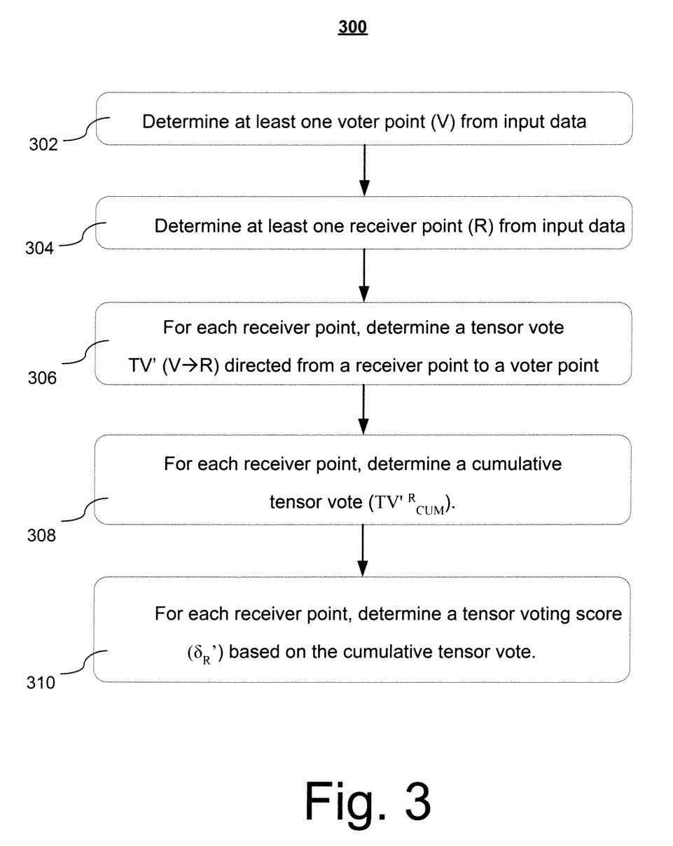

FIG. 3 shows a methodological implementation 300 of a tensor voting scheme. This methodological implementation may be performed in software, hardware, or a combination thereof. For ease of understanding, the method steps are delineated as separate steps; however, these separately delineated steps should not be construed as necessarily order-dependent in their performance or as distinct steps.

At 302, at least one voter point V is determined from input data. In one embodiment, the tensor voting system generates a set of voter points (Vᵢ) from the input data, wherein 1≦i≦Nᵥ. The input data may include, for example, computed tomography (CT) images, magnetic resonance imaging (MRI) data or any other type of input data. For ease of understanding, the input data is described herein as two-dimensional image data. It should be understood that the techniques described herein may be extended to M-dimensional input data, wherein M may be any integer equal to or more than 2.

The number of voter points (Nᵥ) may be equal to or less than the total number of input data points. In one embodiment, voter point V may be located at any input data point. Alternatively, to increase computational efficiency, voter points may be determined by selecting input data points with magnitude |Sᵥ| larger than a threshold value. The threshold value may be determined explicitly, implicitly, heuristically and/or empirically. For example, the threshold value may be derived from the mean of the magnitudes of the input data points. Other methods of determining the threshold value may also be used.

At 304, at least one receiver point R is determined from the input data. In one embodiment, the tensor voting system generates a set of receiver points (Rₖ) from the input data, wherein 1≦k≦N_{R}. The number of receiver points (N_{R}) may be equal to or less than the total number of input data points. In one embodiment, the receiver point R may be located at any input data point. Each receiver point represents a site in M-dimensional space, wherein surrounding voter points Vᵢ vote on whether this receiver point R is within a smooth region or not.

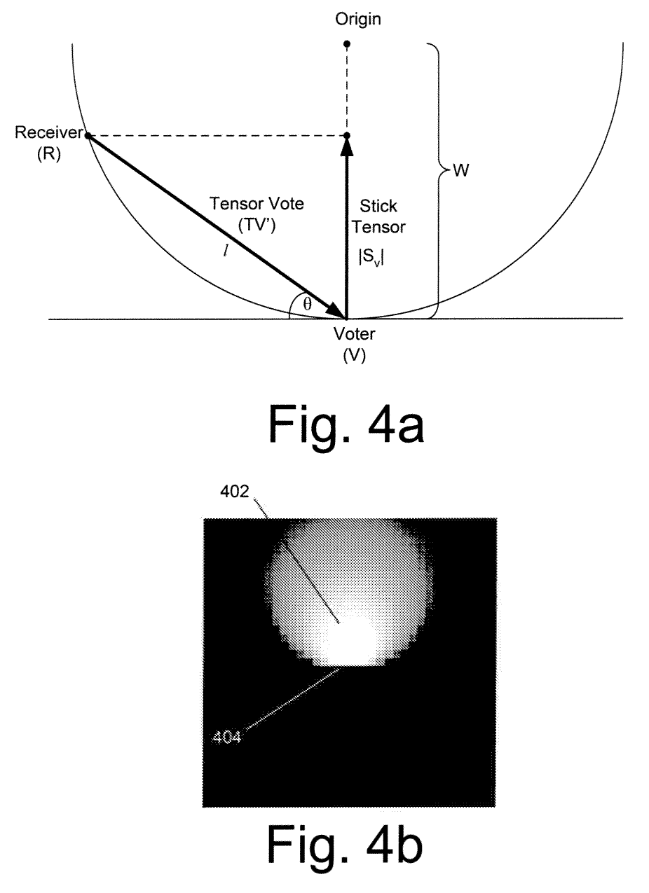

At 306, the tensor voting system determines a tensor vote TV′ (V→R) for each receiver point R. Each voter point V casts a separate tensor vote TV′ on each receiver point R. FIG. 4a illustrates a geometric layout of how the tensor vote TV′ is cast, in accordance with one implementation. Tensor vote TV′ is directed from a receiver point R to a voter point V, thereby giving preference to the interior of the circumscribing circle instead of its boundary. This advantageously allows each voter point V to “illuminate” or emphasize a certain portion of the interior structure based on its own stick tensor.

Tensor vote TV′ may be computed by the following Equation (4):

$$Δ r = {W}^{2} - \frac{{l}^{2}}{2} sin θ where \\ W = \frac{l}{2 sin θ} \\ \begin{matrix}{DF}^{′} ( s , W , σ ) = \vert {S}_{V} \vert {E}_{v} {E}_{l} \\ = \vert {S}_{V} \vert {e}^{\frac{( 1 - 2 {sin}^{3} θ ) + {cW}^{2}}{{σ}^{2}}}\end{matrix} \\ where \\ {E}_{v} = {e}^{\frac{Δ r / {W}^{2}}{{σ}^{2}}} and {E}_{l} = {e}^{\frac{{cW}^{2}}{{σ}^{2}}} \\ {TV}^{′} ( V \to R ) = {{DF}^{′} ( s , W , σ ) [ \frac{- cos θ}{sin θ} ] [ \frac{- cos θ}{sin θ} ]}^{T} \qquad ( 4 )$$

Tensor vote TV′ may be a second order tensor vote. Further, tensor vote TV′ may include a rank-1 positive semi-definite matrix. TV′ is dependent on the orientation of the voter point relative to the receiver point (θ), the distance between the voter point and the receiver point (1), and its stick tensor with magnitude denoted as |Sᵥ|. The stick tensor provides a simple mathematical formulation and a strong relation to edges and/or gradients used in image processing and computer vision applications. Other types of tensors with different tensor orientation and/or magnitudes may also be used.

Tensor vote TV′ is determined by decay function DF′. Decay function DF′, in one embodiment, comprises a voter decay function (Eᵥ) and a distance decay function (E₁), defined under a scale factor (σ). Scale factor σ is a free parameter that determines the resolution of the final solution, by controlling the size of the voting neighborhood and the strength of the votes. For example, a small smooth region has a higher voting response when it is computed using a smaller scale.

Voter decay function Eᵥ encodes the strength of a cast vote as an exponential function of the position of the receiver point relative to the voter point. In one embodiment, the voter decay function Eᵥ favors receiver points that are in the direction of the voter stick tensor. Distance decay function Eₗ encodes the strength of a cast vote as an exponential function of the distance between the receiver point and the voter point.

Mixing factor (c) determines the effect of the distance decay function Eₗ relative to the voter decay function Eᵥ. The mixing factor (c) may be dependent on the scale factor (σ). For example, the smaller the scale factor (σ), the smaller the mixing factor (c). Consequently, the smaller the mixing factor (c), the stronger the voter decay function Eᵥ is relative to the distance decay function Eₗ. In such case, voter points along about the same direction but at farther distances from a receiver point R contribute more than other voter points. Conversely, the smaller the mixing factor (c), the stronger the distance decay function Eₗ is relative to the voter decay function Eᵥ. In such case, voter points closer to the receiver point R contribute more than other voter points.

FIG. 4b illustrates a two-dimensional plot of the decay function DF′ of a voter point at the origin, wherein the magnitude of its stick tensor is a unit length (|Sᵥ|=1) and is directed vertically upward. As can be seen in FIG. 4b, the decay function emphasizes the interior area (402), rather than the edge or boundary (404), of a structure or smooth region.

Referring back to FIG. 3, at 308, a cumulative tensor vote TV^{R}_{CUM} is obtained for each receiver point R. In one embodiment, the cumulative tensor vote TV′^{R}_{CUM} comprises a convex sum of tensor votes cast by Nᵥ voter points on the receiver point R, wherein the contribution of each voter point at a receiver point is weighted by its respective voting strength or weight factor (α), as shown in Equation (5):

$${TV}_{CUM}^{′R} = {\sum }_{i = 1}^{{N}_{V}} {α}_{i} {TV}^{′} ( {V}_{i} \to R ) \qquad ( 5 )$$

Weight factors αᵢ represent the probabilities of the corresponding voter points lying on the boundary of a smooth structure. These weight factors αᵢ allow for communication between the voter points Vᵢ, by numerically conveying the “agreement” of the voter points Vᵢ on their relative “significance.” In one embodiment, a weight factor αᵢ for a corresponding voter point Vᵢ comprises a normalized tensor voting score, as shown in Equation (6).

$${α}_{i} = \frac{{δ}_{{V}_{i}}}{{\sum }_{j = 1}^{{N}_{v}} {δ}_{{V}_{j}}} \qquad ( 6 )$$

The normalized tensor voting score comprises a tensor voting score δᵥᵢ of the corresponding voter point Vᵢ normalized by a sum of tensor voting scores δᵥⱼ of all the voter points Vⱼ, wherein 1≦j≦Nᵥ. Tensor voting score δᵥⱼ for voter point Vᵢ may be determined by tensor votes cast by other voter points on voter point Vᵢ. Similarly, tensor voting score δᵥⱼ may be determined by tensor votes cast by other voter points on voter point Vⱼ. Tensor voting scores δᵥᵢ and δᵥⱼ may be determined by Equations (1)-(3), as described above.

At 310, the tensor voting system determines a tensor voting score δ_{R}′ of the receiver point R Tensor voting score δ_{R}′ comprises an absolute difference between the two eigenvalues of TV′^{R}_{CUM}, as shown in Equation (7):

∴δ_{R}′=λ₁(TV′^{R}_{CUM})−λ₂(TV′^{R}_{CUM}), for λ₁(TV′^{R}_{CUM})≧λ₂(TV′^{R}_{CUM}) (7)

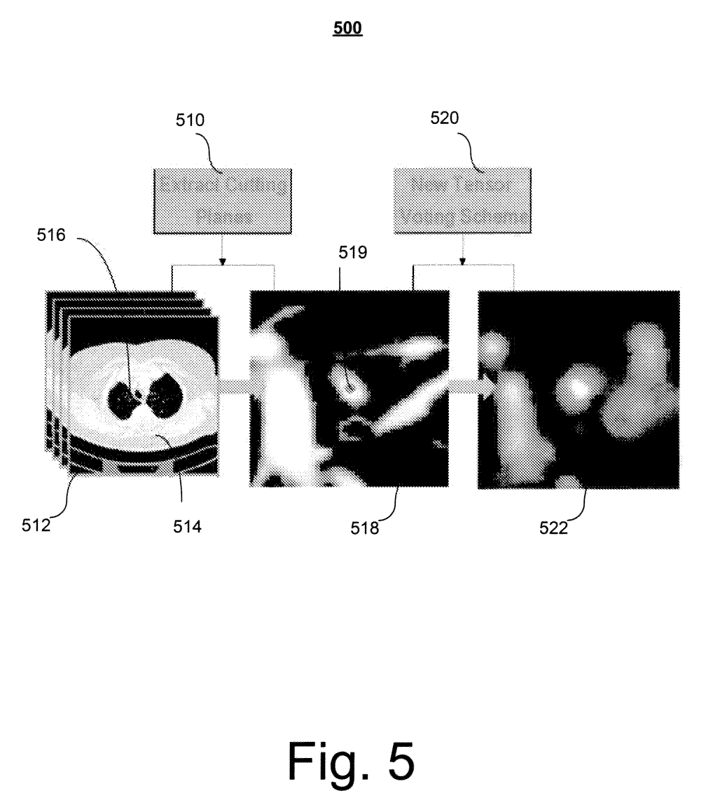

FIG. 5 illustrates an exemplary method 500 of detecting objects in multidimensional data, by applying the tensor voting techniques described herein. This method may be performed in software, hardware, or a combination thereof. For illustrative purposes, the exemplary method 500 will be described with respect to detecting pulmonary embolism (PE). It should be noted that method 500 may be extended to other types of suitable applications.

Generally, pulmonary embolism is a blockage in a pulmonary artery, caused by an embolus that is usually formed in the legs and travels to the heart before reaching the lungs. Such condition is typically very difficult to detect and can cause sudden death if not quickly and correctly diagnosed. The exemplary method 500 advantageously increases the efficiency and accuracy of detecting PE, by effectively discriminating between a pulmonary embolus lying within an artery or blood vessel, and false positives (e.g., lymph nodes) lying outside the artery or blood vessel.

At 510, at least one cutting plane 518 is extracted from multidimensional data 512. In one embodiment, multidimensional data 512 comprises computed tomography (CT) data, such as CT pulmonary angiogram (CTPA) scan data. CTPA is a medical diagnostic test used to diagnose pulmonary embolism. It employs computed tomography (CT) scanners to obtain an image of the pulmonary arteries. A CT image is a large three-dimensional multi-dimensional image, comprising multiple images produced by taking a series of X-ray images. Each X-ray image shows, for example, a slice of a pulmonary vessel 514 filled with contrast, appearing bright white. Any mass filling defects 516, such as an embolus or other matter, will appear dark in place of the white contrast. It should be noted that other types of data, such as magnetic resonance imaging (MRI) data, may also be used.

Multiple cutting planes may be extracted from the multidimensional data 512. Cutting plane 518 is defined about at least one candidate point 519. A candidate point 519 is located at a cluster of suspicious voxels or pixels where a pulmonary embolism is likely to be detected. The suspicious voxels may be determined during a quick preprocessing step. In one embodiment, cutting plane 518 comprises a pre-defined size. The predefined size may be explicitly, implicitly and/or heuristically set according to a chosen scale. The scale may be determined by the decay function, which causes the tensor magnitude to decay below a certain threshold after a certain number of pixels. Alternatively, the pre-defined size comprises the whole multi-dimensional image. Other methods of defining the size of cutting plane 518 are also useful.

Receiver points Rᵢ are located at or near the candidate point 519 of the cutting planes 518. Voter points Vᵢ may be defined on the cutting plane 518 at pixels where gradient energies exceed a predefined threshold. The predefined threshold comprises, for example, the sum of a mean and standard deviation of all the gradient energies within a cutting plane. Other methods of computing the predefined threshold are also useful. The stick tensors for these voter points Vᵢ may be their corresponding two-dimensional gradient vectors.

At 520, tensor voting is performed on the cutting plane 518 to evaluate the probability of the candidate point 519 lying within an artery or blood vessel. For each receiver point Rᵢ located at or near the candidate point, a tensor voting score δ_{R}′ is computed using the tensor voting method 300, described above with respect to FIG. 3. Each pixel in image 522 represents the tensor voting response (i.e. δ_{R}′ value) at each corresponding pixel in the cutting plane 518. The whiter the pixel in image 522, the higher the response, and therefore, the higher the probability that the corresponding pixel in the cutting plane 518 is within a smooth curve at a given scale. Conversely, the darker the pixel, the higher the probability that the corresponding pixel in the cutting plane 518 is at a boundary or outside smooth curves. Based on the tensor voting scores, the presence of a PE candidate may be detected.

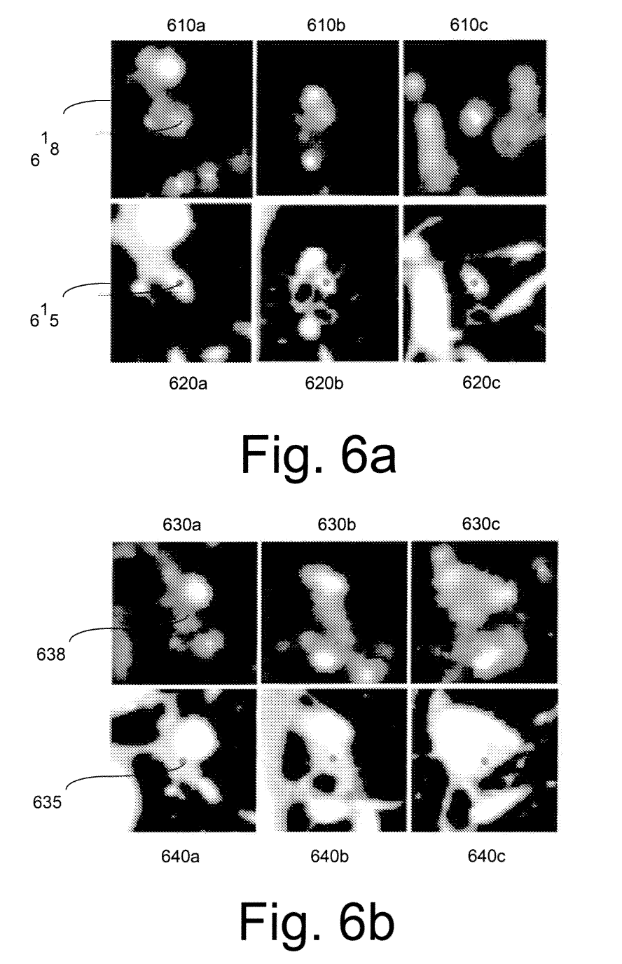

FIGS. 6a and 6b illustrate how the tensor voting scores vary between PE candidates and non-PE candidates (false positives) respectively. FIG. 6a shows images 610a-c of the voting scores of a pulmonary embolism candidate 615 along three cutting planes 620a-c respectively. The three cutting planes correspond to three main directions x, y and z. Although only three cutting planes are shown, any or all possible cutting planes (e.g. 13 planes) may also be used. As can be seen in FIG. 6a, since the PE candidate 615 lies within a smooth boundary of a blood vessel, its corresponding tensor voting score δ_{R}′ is very high, as represented by the white regions 618 in corresponding images 510a-c.

FIG. 6b shows images 630a-c of the voting scores of a non-PE candidate 635 (e.g., lymph node or false positive) along three cutting planes 640a-c. Since the non-PE candidate is lying outside the blood vessel, its corresponding voting score δ_{R}′ is low, as represented by the grey regions 638 in corresponding images 630a-c. Thus, non-PE candidates or false positives may be discriminated from PE candidates by examining the resulting images of tensor voting scores.

The application described herein may be extended to three-dimensional applications. For example, it may be used to detect 3D structures such as sphere-like structures (e.g., pulmonary nodules), half-sphere-like structures (e.g., colon polyps) and tubular structures (e.g., blood vessels and airways).

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. One or more processor-readable media having processor-executable instructions that, when executed by a processor, performs acts comprising:
determining at least one voter point from input data;
determining at least one receiver point from the input data; and
determining at least one tensor vote cast by the voter point on the receiver point, wherein the tensor vote is directed from the receiver point to the voter point.

2. One or more media as recited in claim 1 wherein the tensor vote comprises a second order tensor vote.

3. One or more media as recited in claim 1 wherein the tensor vote is determined by applying a decay function which emphasizes the interior of a structure, the decay function comprising a voter decay function (Eᵥ) and a distance decay function (Eₗ).

4. One or more media as recited in claim 3 wherein the voter decay function comprises an exponential function of a position of the receiver point relative to the voter point.

5. One or more media as recited in claim 3 wherein the distance decay function comprises an exponential function of a distance between the receiver point and the voter point.

6. One or more media as recited in claim 1 further comprising determining a cumulative tensor vote at the receiver point.

7. One or more media as recited in claim 6 wherein the cumulative tensor vote comprises a convex sum of multiple tensor votes cast by multiple voter points on the receiver points wherein each tensor vote is weighted by a weight factor.

8. One or more media as recited in claim 7 wherein the weight factor comprises a normalized tensor voting score of a voter point.

9. A computer comprising one or more processor-readable media as recited in claim 1.

10. A computer-implemented method comprising:
determining at least one voter point from input data;
determining at least one receiver point from the input data; and
determining at least one tensor vote cast by the voter point on the receiver point, wherein the tensor vote is directed from the receiver point to the voter point.

11. The computer-implemented method of claim 10 wherein the tensor vote is determined by applying a decay function which emphasizes the interior of a structure, the decay function comprises a voter decay function (Eᵥ) and a distance decay function (Eₗ).

12. The computer-implemented method of claim 11 wherein the voter decay function comprises an exponential function of a position of the receiver point relative to the voter point.

13. The computer-implemented method of claim 11 wherein the distance decay function comprises an exponential function of a distance between the receiver point and the voter point.

14. The computer-implemented method of claim 10 further comprising determining a cumulative tensor vote at the receiver point.

15. The computer-implemented method of claim 14 wherein the cumulative tensor vote comprises a convex sum of multiple tensor votes cast by multiple voter points on the receiver point, wherein a tensor vote is weighted by a weight factor.

16. A computer-implemented method of detecting an object in multidimensional data comprising:
extracting at least one cutting plane from the multidimensional data;
determining at least one receiver point on the cutting plane;
determining multiple voter points on the cutting plane;
determining multiple tensor votes cast by the voter points on the receiver point, wherein the tensor votes are directed from the receiver point to the voter points;
determining a tensor voting score for each receiver point based on the tensor votes; and
detecting the presence of the object based on the tensor voting score.

17. The computer-implemented method of claim 16 wherein the object comprises a pulmonary embolus lying within a blood vessel.

18. The computer-implemented method of claim 16 wherein the multidimensional data comprises computed tomography (CT) data.

19. The computer-implemented method of claim 16 wherein the determining the tensor voting score comprises computing a difference between two eigenvalues of a cumulative tensor vote.

20. The computer-implemented method of claim 19 wherein the cumulative tensor vote comprises a convex sum of the tensor votes, wherein a tensor vote is weighted by a weight factor.
